(19) United States
(12) Patent Application Publication
(10) Pub. No.: US 2015/0001141 A1
(43) Pub. Date: Jan. 1, 2015

(54) DEVICE FOR GENERATING ELECTRICITY FROM A PRESSURIZED WATER CIRCULATION SYSTEM

(71) Applicant: Michael Wieland, Orlando, FL (US)

(72) Inventor: Michael Wieland, Orlando, FL (US)

(21) Appl. No.: 14/276,701

(22) Filed: May 13, 2014

Related U.S. Application Data
(63) Continuation-in-part of application No. 13/205,898, filed on Aug. 9, 2011, now abandoned.

(51) Int. Cl. H02K 7/18; H02P 9/04; F03B 13/10; E04H 4/12

(52) U.S. Cl. CPC H02K 7/1823; E04H 4/1209; E04H 4/1245; H02P 9/04; F03B 13/10; F03B 17/005
USPC 210/167.1; 290/52; 290/43; 415/916

(57) ABSTRACT

A device for generating electricity from a pressurized water circulation system is disclosed. The device utilizes water flow within a tubular member to provide mechanical force to rotate a rotor. The electrical generator includes a rotor comprising an impeller, wherein the rotor is configured to receive liquid flow within an electromagnetic induction armature from the tubular member, a stator configured to generate electrical energy within a plurality of coils utilizing a magnetic flux generated by the electromagnetic induction armature when rotated adjacent to the stator, and a bypass tubular member configured to selectively route liquid around the electrical generator to adjust voltage of generated electrical energy. The device is operable within a swimming pool circulation system and feeds back electrical power to the pool pump.

### CROSS-REFERENCE TO RELATED APPLICATIONS

This application is a continuation-in-part of, and claims the benefit to copending U.S. application Ser. No. 13/205,898 filed on Aug. 9, 2011, the contents of which are incorporated herein by reference.

### TECHNICAL FIELD

This disclosure is related generally to electrical energy production, and more particularly to a device for generating electricity from the movement of water through a pool circulation system.

### BACKGROUND

The statements in this section merely provide background information related to the present disclosure and may not constitute prior art.

Residential swimming pools are an extremely popular item for many homeowners. Although once considered a luxury afforded only to the few, the availability of low interest loans, combined with advances in construction techniques have made the dream of owning a backyard swimming pool a reality for millions of homeowners across this and other countries.

Residential swimming pool systems typically include the actual swimming pool, along with a water circulation system that includes a water pump, a filter and a series of conduits for moving the water therebetween. The circulation system runs on electricity, and functions (in conjunction with various chemicals) to circulate the pool water to prevent the buildup of pollutants such as algae and other such bacteria. In this regard, many pool circulation systems are designed to circulate the entire volume of water within the system at least 2 times within a 24 hour period.

Unfortunately, due to the rising prices of electricity, many pool owners are finding that it is quite expensive to run their pool circulation system for such long periods of time. As such, many pool owners routinely switch the circulation system off at night, and during ever increasing portions of the day in order to reduce the overall energy consumption of the system. However, when the circulating pump is turned off for extended periods of time, there is a substantial risk that algae and other such pollutants may rapidly overrun the pool. The elimination of these pollutants requires heavy doses of chemicals, the cost of which greatly exceeds the savings in energy that is enjoyed by the reduced operation of the circulation system.

Conversely, commercial swimming pools are required to run the circulation systems 24 hours a day, thereby utilizing extremely large amounts of electricity annually.

Electric generators are well known in the art and used in many electric generation applications such as hydroelectric dams and windmills. Electric generators function, as one skilled in the art will readily recognize, to generate electrical current utilizing a mechanical force supplied from nature, such as provided by wind or water motion, or an extrinsic force such as provided by controlled chemical reactions or by humans such as by pedaling a stationary bicycle.

Although these devices are useful for their respective objectives, there remains a need for a power generation device that is adapted for use with a swimming pool circulation system, in order to generate electricity that can be used to augment the operation of the circulation system itself, or to provide power to an external device.

### SUMMARY OF THE INVENTION

A device for generating electricity from a pressurized water circulation system is disclosed. The device can include a tubular main body for housing an electrical generator that utilizes water flowing through the tube to provide mechanical force to rotate a rotor. The electrical generator includes a rotor comprising an impeller, wherein the rotor is configured to receive liquid flow within the electromagnetic induction armature from the tubular member, a stator configured to generate electrical energy within a plurality of coils utilizing a magnetic flux generated by the electromagnetic induction armature when rotated adjacent to the stator, and a bypass tubular member configured to selectively route liquid around the electrical generator to adjust voltage of generated electrical energy.

Certain embodiments of the disclosure include an elongated impeller moveably connected to an electromagnetic induction armature and configured to magnetically rotate the electromagnetic induction armature when rotating within the electrical generator. In this way, certain gear elements of known electrical generators may be excluded from the electrical generator, minimizing physical space requirements and increasing efficiency.

Certain embodiments of the disclosure include a circular impeller directly connected to the electromagnetic induction armature and configured to directly move the electromagnetic induction armature when propelled by liquid flow within the electrical generator. Electrical generator embodiments including a circular impeller embodiment are preferably adapted specifically for certain applications including certain parameters of liquid flow within the tubular member for preferential operation.

Certain embodiments of the disclosure include a system that includes an electrically powered pool pump, a pool filter and a plurality of water supply lines that are connected to the device and the electrical energy generated by the device is fed back to the pool pump to augment the power requirements of the same.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1A illustrates one embodiment of the device for generating electricity from a pressurized water circulation system, that is useful for understanding the inventive concepts disclosed herein.

FIG. 1B schematically shows a partial sectional view of the device for generating electricity from a pressurized water circulation system and corresponding electrical circuit, in accordance with the present disclosure;

FIG. 2 schematically shows a second embodiment of the electrical circuit, in accordance with the present disclosure;

FIG. 3 shows a water volume regulator used to control voltage in the device for generating electricity from a pressurized water circulation system, in accordance with the present disclosure;

FIG. 4 is a cross-sectional view of the device for generating electricity from a pressurized water circulation system, in accordance with the present disclosure;

FIG. 5 schematically shows coils of the device for generating electricity from a pressurized water circulation system, in accordance with the present disclosure;

FIGS. 6A and 6B show exemplary embodiments of the impeller used in the device for generating electricity from a pressurized water circulation system, in accordance with the present disclosure;

FIG. 7 shows a top view of the impeller shown in FIG. 6A, in accordance with the present disclosure;

FIG. 8A shows an alternative embodiment of the electric generator system using an alternative embodiment of the impeller that is shown in FIG. 8B, in accordance with the present disclosure;

FIG. 9 is a partial sectional side view of an input tube into the device for generating electricity from a pressurized water circulation system and coupling means, in accordance with the present disclosure; and

FIG. 10 illustrates an exemplary user interface for controlling operation of the device for generating electricity from a pressurized water circulation system, in accordance with the present disclosure.

FIG. 11 illustrates one embodiment of the device for generating electricity from a pressurized water circulation system in operation.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

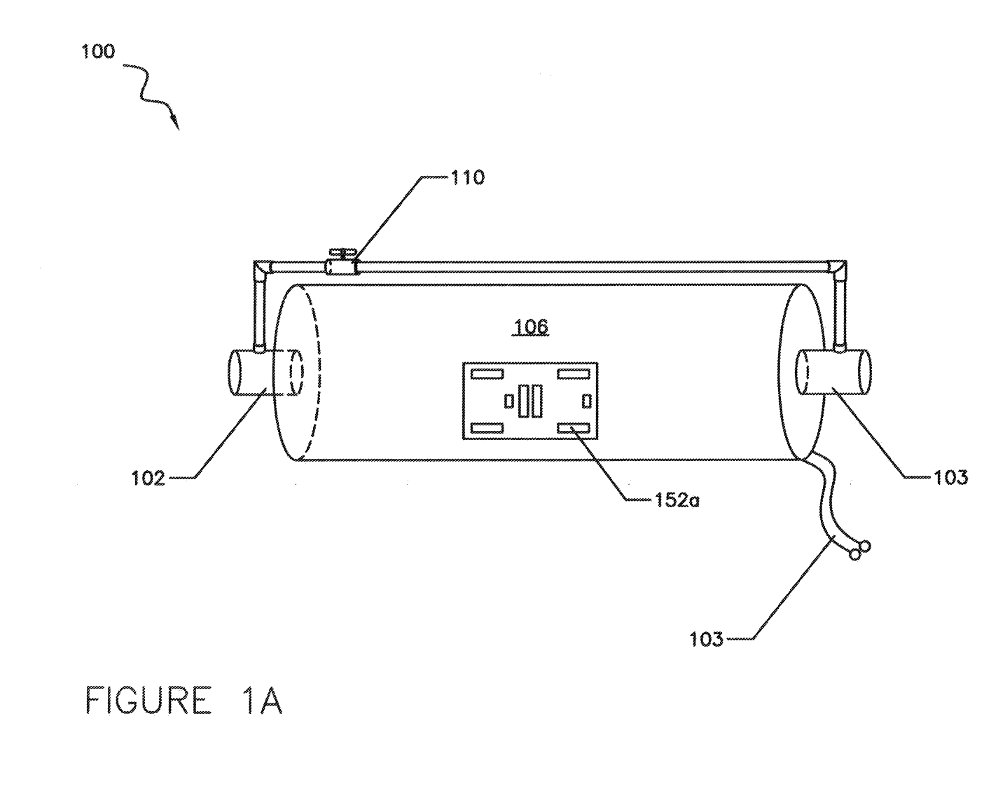

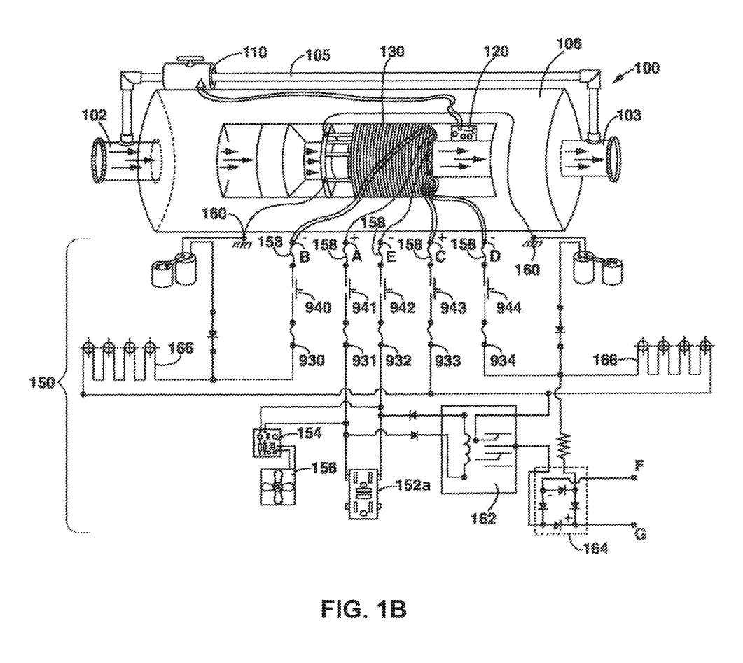

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1A.

As will be described throughout this disclosure, the device for generating electricity from a pressurized water circulation system can function as an electrical feedback system to augment the power requirements of a swimming pool pump/motor. Of course, the invention is not to be construed as limiting to this function, as many other uses and adaptations are also contemplated. As described throughout this document, the terms “pressurized water flow” and variants of the same can refer to any body of water that is moving or in a compressed state.

Referring now to the drawings, wherein the showings are for the purpose of illustrating certain exemplary embodiments only and not for the purpose of limiting the same, FIGS. 1A and 1B schematically illustrate one embodiment of a device for generating electricity from a pressurized water circulation system 100, and an exemplary electrical circuit 150 for utilizing the device 100.

As shown, the device 100 can include an elongated, generally tubular main body 106, having an input tube 102 for receiving pressurized water from a pool circulation system, an output tube 103 for returning the pressurized water back to the pool circulation system, an electrical generator 130, a water volume regulator 110, a voltage control unit 120, and an electrical output 152.

In the preferred embodiment, the main body 106 can be constructed from a lightweight material such as PVC, for example, which is durable, non-electrically conductive, and does not rust when constantly subjected to water. Moreover, it is preferred that the entire device be lightweight, portable and small in nature, so as to be easily mated with the pool circulation system. Accordingly, in one embodiment, the main body 106 can include a length of approximately 24 inches, and a diameter of approximately 6 inches, and each of the inlet and output tubes 102 and 103, can also preferably be constructed from pieces of PVC pipe that are sized to mate with the circulation pipes of the swimming pool circulation system. Such pipes typically including a dimension of between 1.5 inches to 3 inches, depending on the horsepower of the pool pump.

Although described above as utilizing particular construction techniques, dimensions, and construction this is for illustrative purposes only, as any number of other shapes, sizes and materials are also contemplated. For example, in another embodiment, one or more of the inlet and output tubes 102 and 103 can be positioned at a generally oblique angle to the main body, and can include different dimensions to each other.

The electrical generator 130 preferably includes stator(s), rotor(s), and/or additional components configured to generate electrical power using mechanical power. In one embodiment, the electrical generator 130 is additionally configured to selectively operate as an electric motor. The electric motor may serve, in particular applications, as a supplemental or backup pump to drive flow of the liquid. Additionally, the electrical generator 130 may be configured to selectively operate in forward and reverse directions when operating as either a motor or a generator. The electrical generator 130 is preferably connected to the electrical circuit 150 at nodes A, B, C, D, and E as shown in FIG. 1B. The nodes A, B, C, D, and E are connected to coil strands of the electrical generator 130. As one skilled in the art will readily recognize, multiple arrangements of connections to the electrical generator 130 are possible based upon functions and components within the electrical circuit 150 and the disclosure herein is therefore not intended to be limited to the particular connection arrangement shown in the figures or discussed herein.

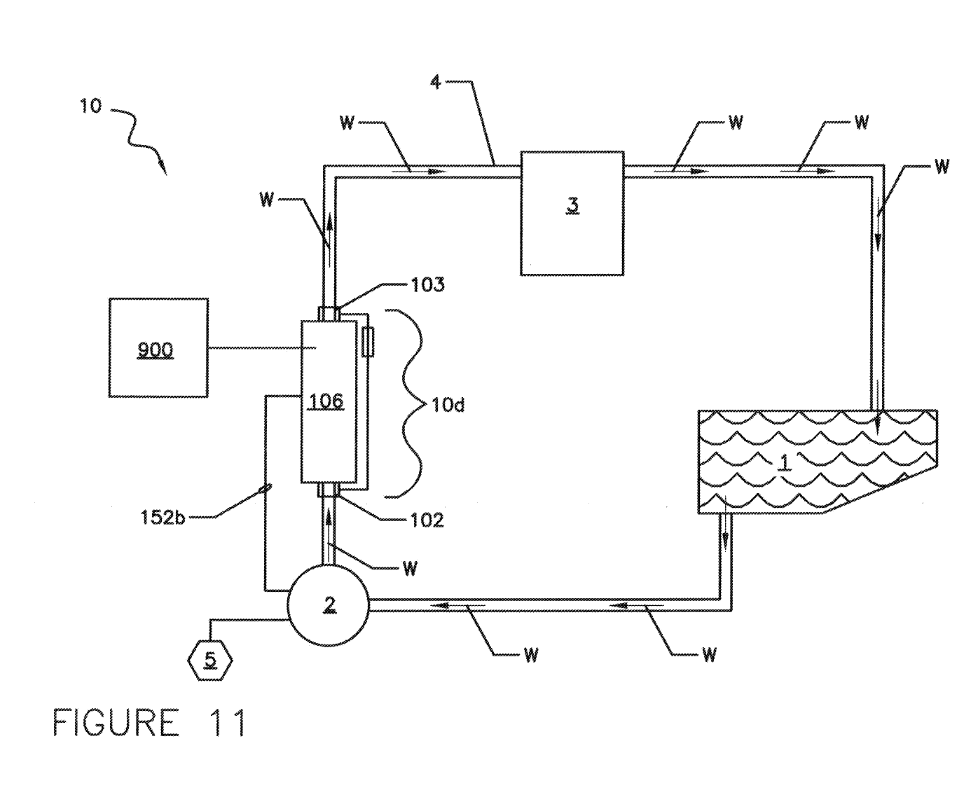

The electrical circuit 150 includes exemplary components that may be included to utilize electricity generated by the device 100. The electrical circuit 150 preferably includes electrical components configured to modulate electrical energy generated by the device 100 into an alternating current. In one embodiment, energy generated by the device 100 is modulated to produce electrical current at substantially 60 Hz and at substantially between 110 and 120 volts. Such a modulation would electrically power many standard consumer products when electrically connected to a conventional ground fault interrupter or ground fault circuit interrupter outlet, such as outlet 152a shown in FIG. 1B. However, the device can also be configured to produce electrical current at different Hz and/or voltages, and can further include any number of power cables 152b (See FIG. 1A) suitable for direct wiring the electrical output of the device into a secondary device, such as the pool pump 2 illustrated in FIG. 11, for example.

The electrical circuit 150 may include a step-down circuit 154 configured to produce direct current at a predetermined voltage. A cooling fan 156 is preferably included in the electrical circuit 150 to reduce thermal energy within the device 100 and preferably powered by the step-down circuit 154. A plurality of fuses 158 may be included on the electrical circuit 150 to protect the device 100 from electrical surges or damaging thermal energy. The plurality of fuses 158 may include multiple fuse types configured for connecting components of the electrical circuit 150 with components of the electrical generator 130 when operating within predetermined parameters. In one embodiment, the plurality of fuses 158 are thermal fuses configured with a thermo-sensitive material to melt at a predetermined temperature thereby disconnecting the electrical generator 130 and components of the electrical circuit 150 when an undesirable operating temperature is achieved. Additional fuses 930, 931, 932, 933, and 934 may be included for additional protection.

The electrical circuit 150 preferably includes grounding components 160 to electrically ground the electrical generator 130 such as via a wire connected to a ground, wire connected to the housing 106, and/or similar means as well known in the art. As shown in FIG. 1B, the electrical circuit 150 is configured to produce electrical current at points F and G, utilizing a relay 162 and a diode bridge 164. As an exemplary electrical load, lighting devices 166 are included in the electrical circuit 150. A plurality of switches 940, 941, 942, 943, and 944, or connectors in one embodiment, may be included for convenient operating state changes of electrical components and functions. Various additional electrical components are utilized in the electrical circuit 150 including capacitors, diodes, and resistors, as shown in FIG. 1B. As one skilled in the art will recognize upon reading the teachings of this disclosure, quantity, operating parameters, and arrangement of the various electrical components may be changed for a particular embodiment of the device 100 and for particular applications of the device 100.

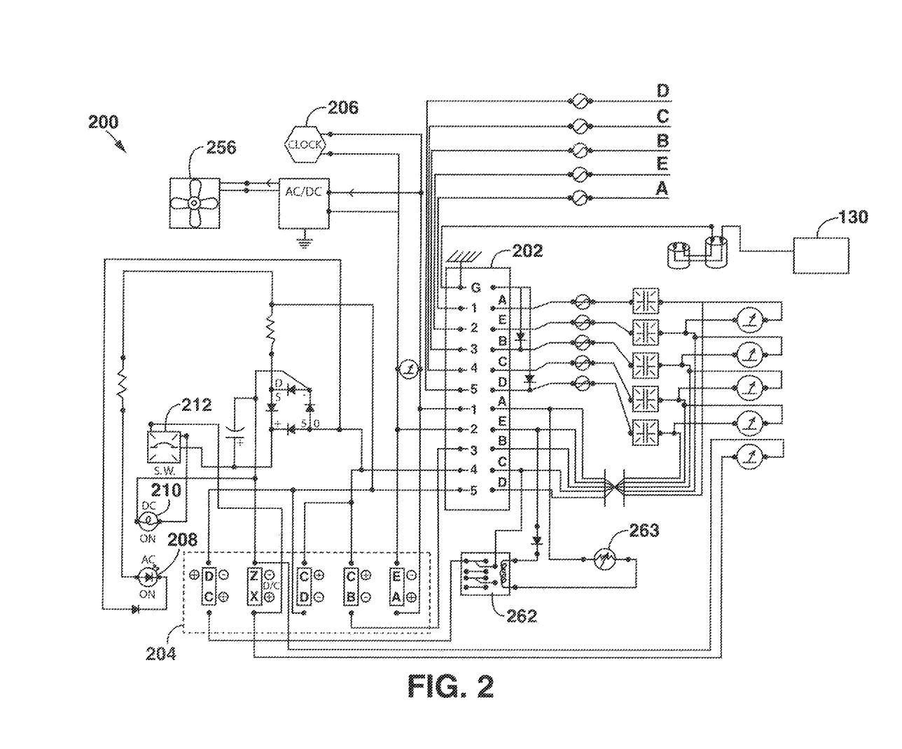

FIG. 2 schematically shows a second electrical circuit 200. The second electrical circuit 200 is an alternative embodiment of the electrical circuit 150 and may be used in more energy efficient applications of the device 100. The second electrical circuit 200 may be connected to the coils within the electrical generator 130 at nodes A, B, C, D, and E as shown in FIG. 2. The electrical circuit 200 includes a circuit board 202 configured to electrically connect portions and components of the electrical circuit 200. The circuit board 202 may be any known board including any number of conducting layers separated by insulating layers. As shown in FIG. 2, connecting nodes on the circuit board 202 are indicated by a same character or number. Node 1 is connected to node A; node 2 is connected to node E; node 3 is connected to node B; node 4 is connected to node C; and node 5 is connected to node D.

The second electrical circuit 200 includes a number of electrical components that may be adapted for a particular application of the device 100. The second electrical circuit 200 includes terminal outputs 204 and a clock 206. An ON operating state of AC power is indicated by a first lighting device 208, preferably a light emitting diode. An operating state of DC power may be controlled using a switch 212, whereby an ON operating state is indicated by a second lighting device 210. A relay 262 is connected to a photoelectric switch 263 configured to power an electrical device when activated. A step-down circuit 254 is configured to produce direct current at a predetermined voltage. A cooling fan 256 is preferably included to reduce thermal energy within the device 100 and powered by the step-down circuit 254. Additional electrical components are included as shown in FIG. 2 and function as understood by one skilled in the art from a careful reading of this disclosure.

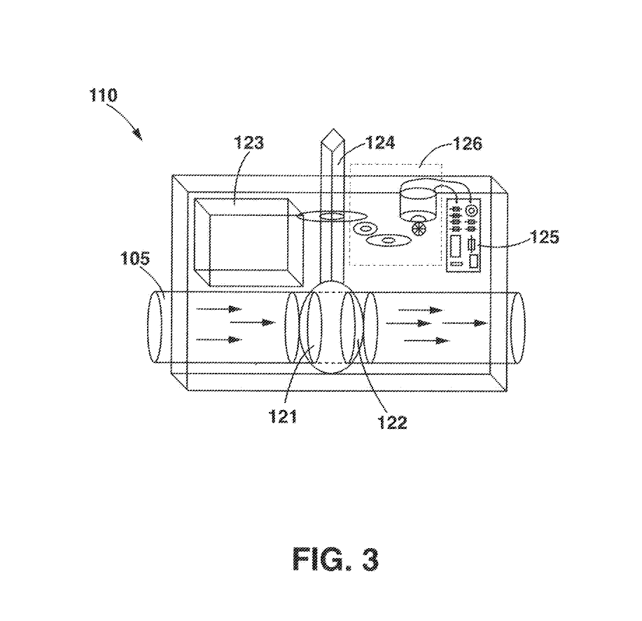

FIG. 3 shows one embodiment of the water volume/flow regulator 110. As FIG. 3 shows, the regulator 110 can be configured to control a magnitude of water flow routed around the electrical generator 130 utilizing a bypass tube 105 by controlling a magnitude of an opening 121 into the bypass tube 105 (i.e., non-discrete manner). Although dimensions will vary, the bypass tube 105 will typically include a diameter that is approximately ½ the diameter of the main body.

The water volume regulator 110 is preferably controlled using the voltage control unit 120 as shown in FIG. 1B. Flow rates into the electrical generator 130 affect voltage levels of the electrical energy produced. For example, routing water around the electrical generator 130 decreases flow rate into the electric generator. Therefore, by controlling a magnitude of the flow rate into the bypass tube 105 a voltage level produced by the electrical generator 130 may be changed be attenuated or enhanced. The voltage control unit 120 is configured to control the magnitude of the flow rate into the bypass tube 105 by controlling a magnitude of the opening 121 within the liquid regulator 110. The water regulator 110 may include a ball valve 122 powered using an electrical energy storage device such as a battery 123, or can be powered via the electrical output of the device 100 itself. In one embodiment, a manual bypass adjustment means 124 is included to adjust the ball valve 122. A circuit board 125 is preferably communicatively connected to the voltage control unit 120 and configured to control a gear box 126 configured to selectively move the ball valve 122.

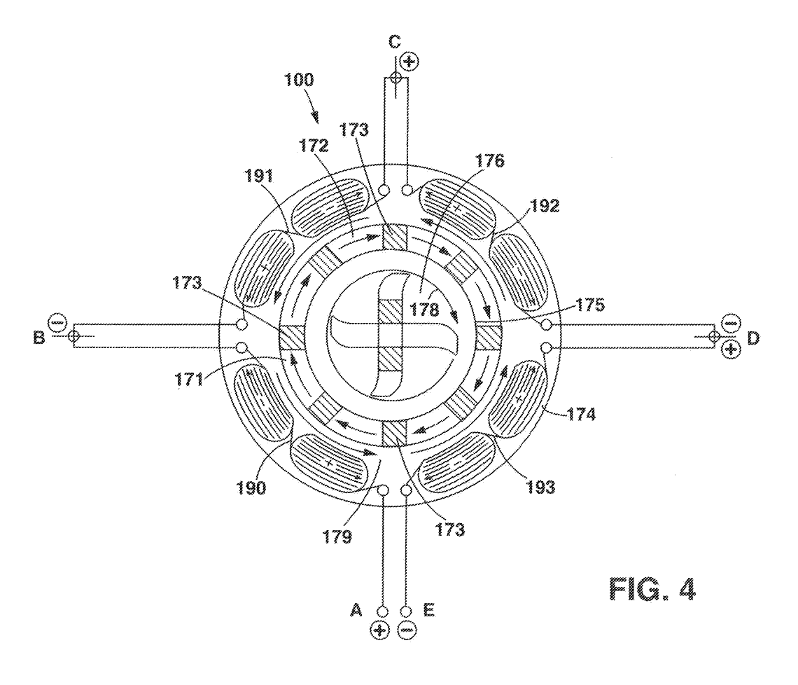

FIG. 4 shows a cross-sectional view of the electric device 100 from a perspective of substantially perpendicular liquid flow into the system. As FIG. 4 shows, the electric device 100 includes an impeller 170, electromagnetic induction armature 172 and stator 174. The stator 174 includes a first, second, third, and fourth set of coils 190, 191, 192, and 193. As one skilled in the art will recognize from a reading of this disclosure, the number and arrangement of sets of coils can differ in alternate embodiments including embodiments wherein the electrical circuit 150 includes additional components and functionality. In physically larger applications of the present disclosure, multiple additional sets of coils and/or multiple additional sets of coils serially or parallel connected to one of the first, second, third, and fourth set of coils 190, 191, 192, and 193 may be included.

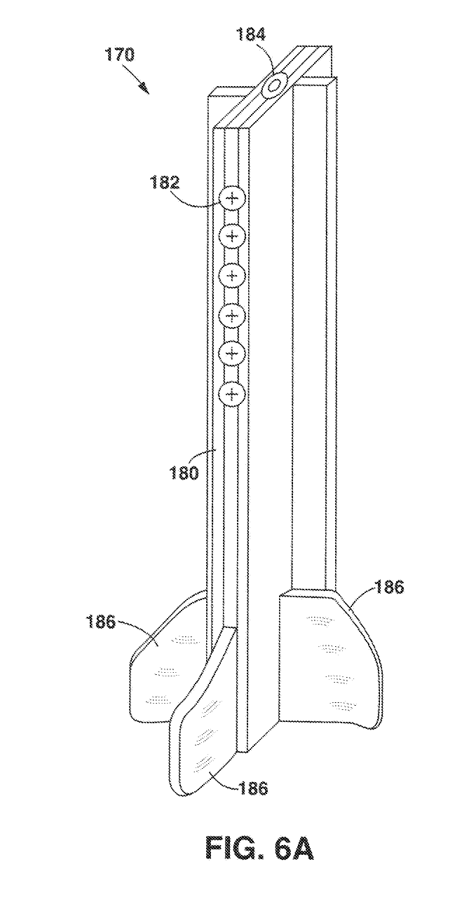

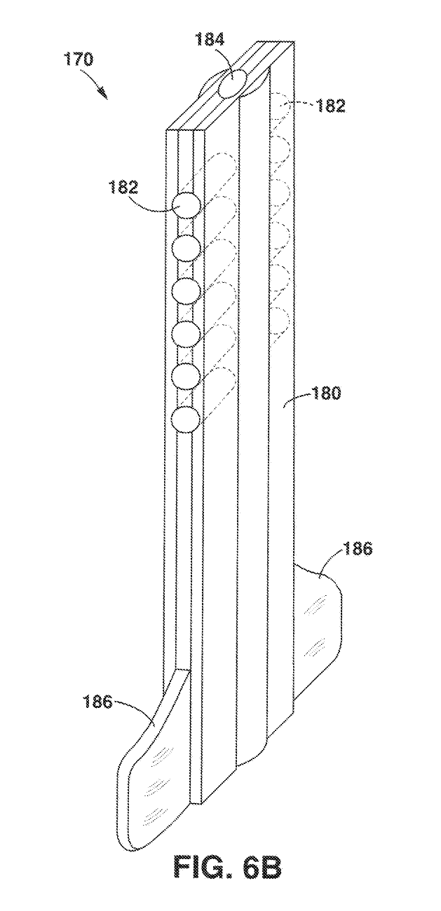

The impeller 170 and the electromagnetic induction armature 172 functions as a rotor in the electrical generator 130. The impeller 170 includes a plurality of magnets as described herein below and shown in exemplary embodiment in FIGS. 6A and 6B. The electromagnetic induction armature 172 includes a plurality of magnets 173, and is moveably connected to the stator 174, preferably using a ring of ball bearings or similar connection means. The impeller 170 is moveably connected to the electromagnetic induction armature 172 using sealed bearings and is configured to moveably rotate in a first direction 178 when propelled by motion of liquid within a cavity 176. The sealed bearings may be any known type including ceramic or porcelain sealed bearings.

The electromagnetic induction armature 172 is configured to generate a magnetic flux in a direction 179 when rotated in a direction 171 adjacent to the stator 174. In operation, motion of the magnets within the impeller 170 generate a magnetic force that attracts the magnets 173 within the electromagnetic induction armature 172 compelling motion of the electromagnetic induction armature 172 in a same direction as the impeller 170. For example, as shown in FIG. 4, clockwise motion 178 of the impeller 170 compels clockwise motion 171 of the electromagnetic induction armature 172 generating a magnetic flux in an opposite, counterclockwise motion 179. The generated magnetic flux induces an electrical current within the coils 190, 191, 192, and 193. Strength of the electrical current generated is based upon, in part, liquid flow rate, magnetic strength, and the number of turns of the coil.

The electromagnetic induction armature 172 is additionally configured to minimize impediment of liquid flow within the electrical generator 130. Walls 175 of the electromagnetic induction armature 172 are preferably adapted to a piping system to enable continuous liquid flow without substantial turbulence from the walls 175 and out from the output tube 103 to a coupled pipe or tube.

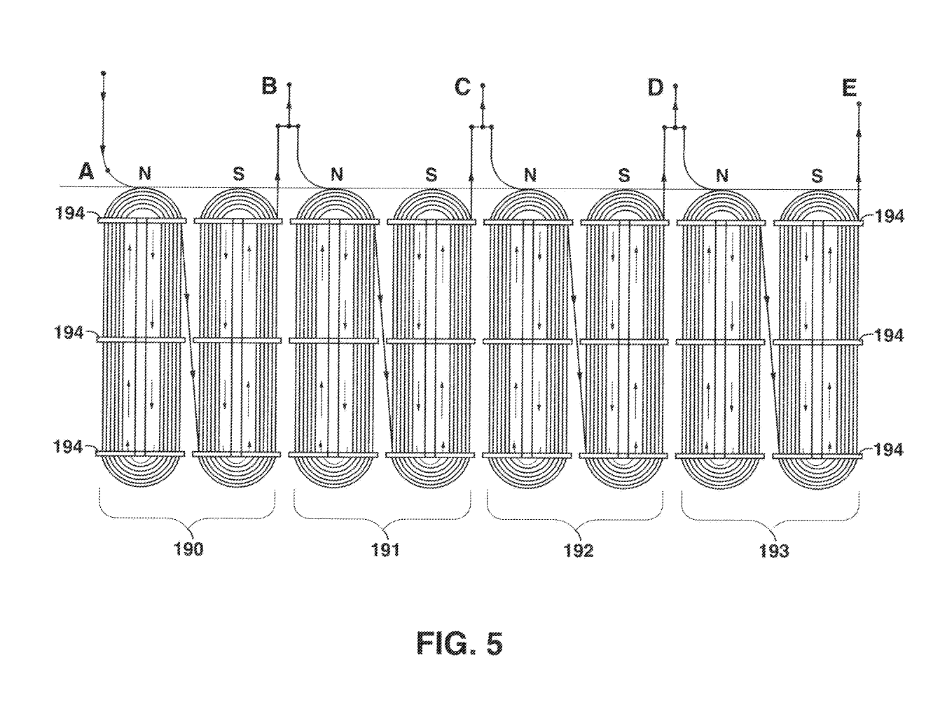

FIG. 5 schematically shows the first, second, third, and fourth set of coils 190, 191, 192, and 193 used to generate electricity in the electrical generator 130. The coils used in the electrical generator 130 may be any known type and gauge adapted for use in a particular application. For example, physically larger embodiments of the present disclosure may more efficiently utilize smaller gauge coil. In one embodiment, the coils are 18 gauge wire and preferably insulated. In one embodiment, the wire is insulated with an enamel coating. The coils function, as one skilled in the art will recognize, to generate electrical current when a magnetic flux is applied to the coils 190, 191, 192, and 193.

As FIG. 5 shows, the first set of coils 190 is connected between node A and node B on the electrical circuit 150. The second set of coils 191 is connected between node B and node C on the electrical circuit 150. The third set of coils 192 is connected between node C and node D on the electrical circuit 150. The fourth set of coils 193 is connected between node D and node E on the electrical circuit 150. The coils 190, 191, 192, and 193 are wound in a figure-eight arrangement, with an electromagnetic north (“N”) and south (“S”) polar region. The coils may be wound into multiple additional shape embodiments including, for example, circular, oval, octagon rectangle, triangle, and square shapes. Multiple coil support members 194 may be included to secure the coils 190, 191, 192, and 193 to the stator 174. The coil support members 194 may be constructed from any known nonconductive material such as plastic, fiberglass, and/or carbon fiber plastic. As described herein above, size, length, and gauge of the coils 190, 191, 192, and 193 may be adapted to a particular application of the electrical generator 130.

FIGS. 6A and 6B show exemplary embodiments of the impeller 170. FIG. 6A shows a four-blade embodiment of the impeller 170, while FIG. 6B shows a two-blade embodiment of the impeller 170. As FIGS. 6A and 6B show, the impeller 170 includes an elongated shaft 180 and a plurality of blades 186. The blades 186 are each configured to generate rotational force from motion of the liquid flow through the electrical generator 130. As one skilled in the art will readily recognize, the number of blades may vary based upon the particular application of the device 100 and is therefore not intended to be limited thereby. The shaft 180 includes a plurality of magnets 182 preferably configured on each side of the shaft 180, i.e., approximately 180-degree difference distance. The shaft 180 further includes an axle apparatus 184 configured to permit free rotation of the impeller 170 during operation preferably concentrically aligned with the stator 174. The magnets 182 may be of any known magnetized material including neodymium magnets. In one embodiment, the magnets are rated between N40 to N52. The impeller 170 may be constructed using one of multiple materials including plastic-fiberglass, plastics, polyethylene, embodiments of carbonic plastic non-magnetic metals, and aluminum.

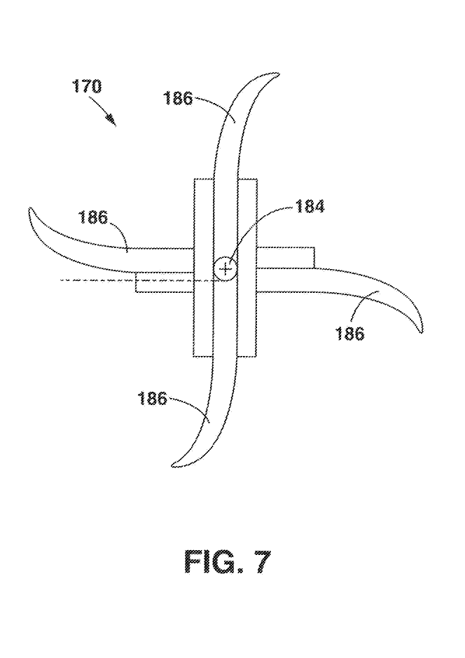

FIG. 7 shows a top view of the impeller 170 shown in FIG. 6A. As FIG. 7 shows, the exemplary impeller 170 includes four blades 186; each blade 186 is of a substantially same shape and size. Alternative embodiments of the impeller 170 may include any number of blades including embodiments having three or more blades, wherein a blade size and shape may be adapted for the particular application and may vary among the blades.

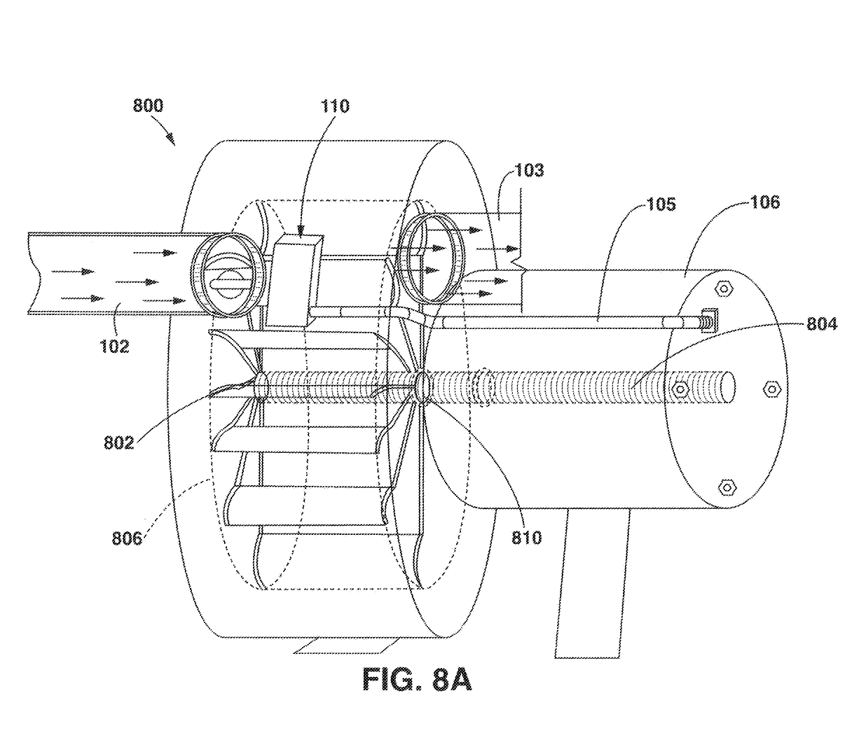

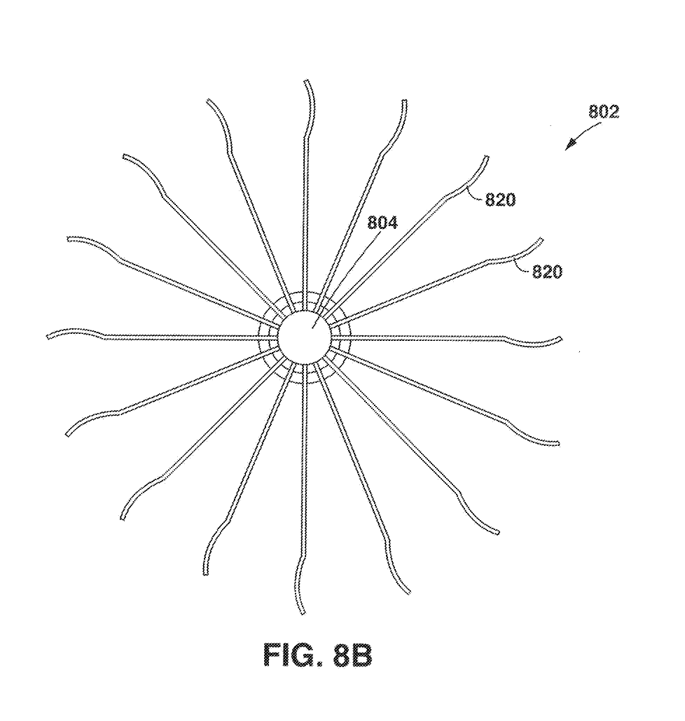

FIG. 8A shows an alternative electric generator system embodiment 800 of an electric device 100 using an elliptical impeller 802 that is shown in FIG. 8B. As FIG. 8A shows, the elliptical impeller 802 is rotatably attached to an axle 804 enabling the elliptical impeller to rotate freely within a sealed chamber 806. In one embodiment, the elliptical impeller 802 is attached to the axle 804 using sealed ball bearings 810. The axle 804 is mechanically connected to an electric generator configured to generate electrical energy using rotational movement of the axle 804. Liquid flow from the input tube 102 to the output tube 103 generates rotational force rotating the elliptical impeller 802 and the axle 804. In one embodiment, the input tube 102 is connected to the sealed chamber 806 using a butterfly valve.

FIG. 8B shows the elliptical impeller 802, an alternative embodiment of the impeller 170. The elliptical impeller 802 is configured to propel an electrical generator, such as the electrical generator 130 described herein above, using motion of liquid flow through the sealed chamber 806. The elliptical impeller 802 includes a plurality of blades 820. The blades 820 are each configured to generate rotational force from motion of the liquid flow. As one skilled in the art will readily recognize, the number of blades may vary based upon the particular application of the generator system 800 and is therefore not intended to be limited thereby. The blades rotate in a circular manner around the axle 804.

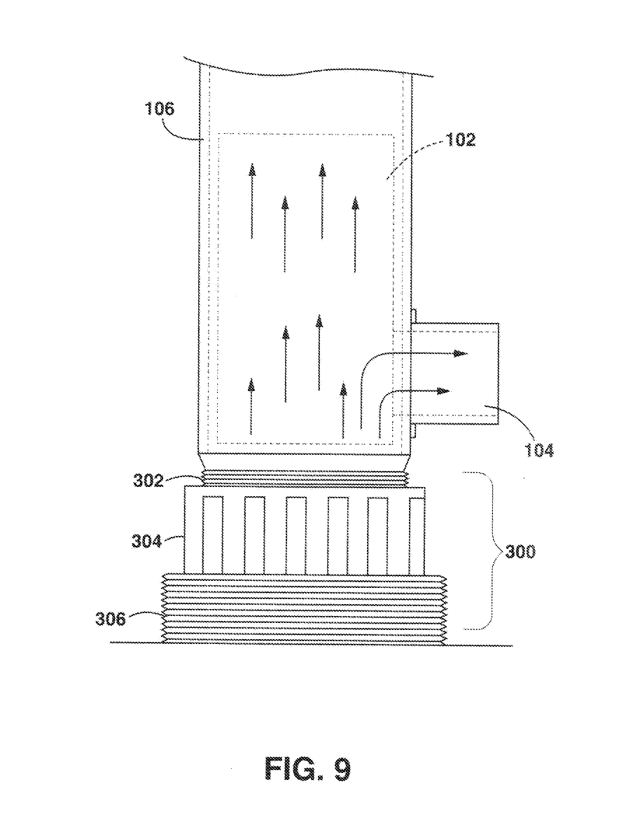

FIG. 9 is a partial sectional side view of the input tube 102 and coupling means 300 for an exemplary application of the device 100. The exemplary application includes coupling the device 100 to ends of a tube or piping apparatus such as a PVC pipe thereby permitting liquid to flow through the device 100. The coupling means 300 can include seals, spacers, and rubber gaskets all configured to prevent liquid leaks and smooth, unencumbered flow of liquid. As one skilled in the art will readily recognize, the output tube 103 may be similarly coupled.

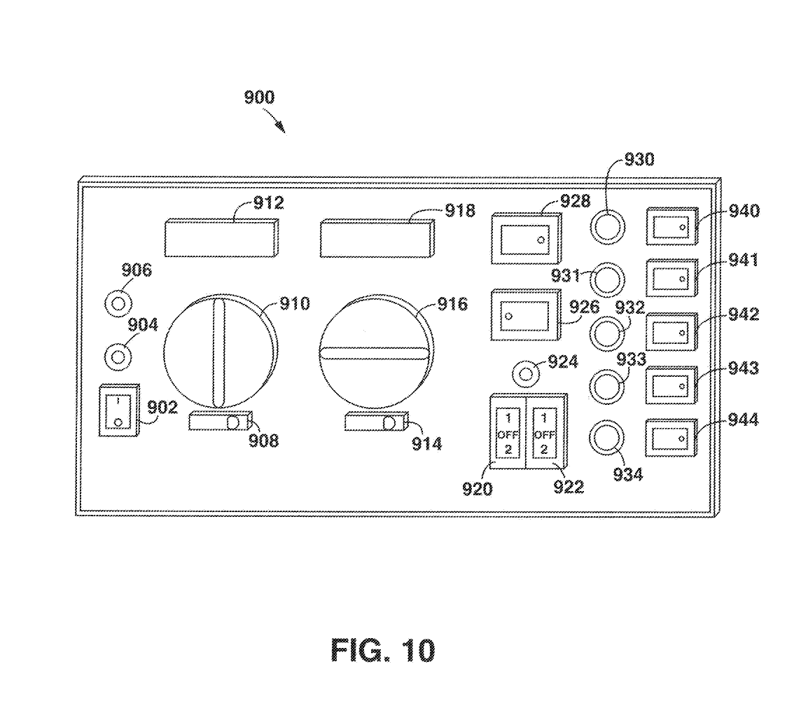

FIG. 10 illustrates an exemplary user interface 900 for controlling operation of the device 100. The user interface 900 can include one or more controls, such as buttons, switches, and dials configured to control operation of the device 100. For example, in one embodiment, the user interface 900 utilizes a touch screen and digital controls to control operation of the device 100. As FIG. 10 shows, the exemplary user interface 900 includes a plurality of switches, dials, and lights for transmitting operational information to a user such as an operating state of a particular component or functionality. A first switch 902 is configured to control a source of direct current power from the electrical generator 130. A first lighting device 904 is configured to indicate an ON operating state of the direct current power source. A second lighting device 906 is configured to indicate an OFF operating state of the direct current power source. In one embodiment, the first lighting device 904 emits a green light when activated. In one embodiment, the second lighting device 906 emits a red light when activated.

A second switch 908 controls an operating state of a first multimeter device. A dial 910 controls a monitoring state of the first multimeter device including orders of magnitude for AC magnitude measurements and DC magnitude measurements. A first display device 912 displays monitored readings of the first multimeter device. A third switch 914 controls an operating state of a second multimeter device. A dial 916 controls a monitoring state of the second multimeter device including orders of magnitude for AC magnitude measurements. A second display device 918 displays monitored readings of the second multimeter device.

Third and fourth switches 920 and 922 are preferably configured to control power sources outputs to AC and DC operating states. A lighting device 924 is configured to indicate whether an AC power source is at an ON operating state. Switches 926 and 928 are configured to switch monitoring of coils within the electrical generator 130 when actuated. In one embodiment, switch 926 is configured to change monitoring from a B-C′ node electrical power reading to a ‘C-D’ node electrical power reading, and switch 928 is configured to change monitoring from a ‘C-D’ node electrical power reading to a B-D′ node electrical power reading using one of the multimeter devices.

The user interface 900 additionally includes access to the fuses 930, 931, 932, 933, and 934 which may be configured with lighting functionality, wherein a fuse emitting a light indicates a functioning fuse. Switches 940, 941, 942, 943, and 944 control connections to coils within the electrical generator 130. As shown in FIG. 1B, switch 940 controls connection to node B. Switch 941 controls connection to node A. Switch 942 controls connection to node E. Switch 943 controls connection to node C. Switch 944 controls connection to node D.

As described herein, the user interface 900 can be constructed as a separate physical unit that is connected to the device 100 via cables and the like. Alternatively, the user interface 900 can be physically mounted to, or embedded within the main body 106 of the device, so as to create a unitary device encompassing the device 100 and the interface 900.

FIG. 11 illustrates one embodiment of the device for generating electricity from a pressurized water circulation system in operation. In the present example, the pressurized water circulation system can include a swimming pool 1 that is in communication with a pool pump 2 and a filter 3 via a plurality of water supply lines 4. In one embodiment, the water supply lines include variable lengths of PVC pipes, and the pool pump can comprise a conventional single or variable speed pump having an integrated motor and strainer, although other embodiments are also contemplated. The pump 2 is connected to an outside power source 5 such as the commercial electric grid, for example, and the flow of water W flows through the system as shown.

In the preferred embodiment, the device 100 is interposed between the output of the pump 2 and the input of the filter 3. Such a location is preferred, because it is at this location where the flow of water through the lines is at its highest pressure. In this regard, the input tube 102 can be serially aligned with the pump 2, and the output tube 103 can be serially aligned with the pool filter 3. As shown, the electrical output 152b of the device 100 can be connected back to the pump 2, in order to augment the power supplied to the pump by the outside power source 5. Such a feature creating a system 10 for circulating water throughout a pool while simultaneously generating and feeding back electrical energy to the pump. The process can be controlled by the controller 900 which can be located on the main body of the device 100, or at any convenient location for access by a user.

In operation, and when utilized with a standard 2.5 horsepower motor generating a flow of 78.4 gallons per minute within the pool circulation system, the device 100 can generate a constant electrical output of 122 volts. As described above, by positioning the device in-line with the circulation system, the electrical generator of the device functions to convert the mechanical force of the flowing water into an electrical output for dissemination to other devices.

When this electricity is fed back to the pump 2, the pump will not require as much energy from the electrical grid 5, thereby greatly increasing the coefficient of performance of the pump itself, and thus allowing the pump to operate for much longer periods of time without incurring the added cost of electricity from the grid 5.

Although not illustrated, the device 100 can include any number of couplers such as PVC fittings, threaded elements and the like in order to secure the device within the circulation system. Moreover, in instances where the pump 2 and filter 3 are located in close proximity, the device 100 can be directly connected to each device, and can serve as the only means for transporting the water directly from the pump to the filter.

Because the device 100 is lightweight, efficient and is installed in-line with the water lines 4 of the pool circulation system, operation of the device has a negligible effect on the flow of water through the system itself. In this regard, and for exemplary purposes only, table 1 below provides test results illustrating the relationship between the device 100 and a pool pump. In the present example, the pool pump is a commercially available Hayward® 2.5 HP pool pump.

TABLE 1

| | Pool pump without | Pool pump with |
|---|---|---|
| | device 100 | device 100 |
| | installed | installed |
| Flow Rate (2″ outlet) | 80 Gallons Per Minute | 78.4 Gallons Per Minute |
| Measured Amperage | 11.52 to 11.56 | 11.34 to 11.41 |
| Measured Voltage | 230 v | 230 v |
| RPM | 3450 | 3381 |
| PSI | 7 | 22 |

The test results embodied in table 1 demonstrate that when the device 100 is installed into a pool circulation system, as described above, the Gallons Per minute and the revolutions per minute of the pump drop by approximately 2% due to the resistance of the device 100. As a result, by lowering the speed of the pump, the amperage draw of the pump also lowers, thus increasing the energy efficiency of the pump. This scenario is similar to the light dimmer on an incandescent bulb that restricts the flow of electrons.

In furtherance of the results listed above, table 2, shows the electrical power output of one embodiment of the device 100 in operation.

TABLE 2

| | | Load Up | | | | Bypass |
|---|---|---|---|---|---|---|
| | | To 10 | | | Voltage | Open to |
| Terminals | No Load | Amps | R.P.M. | P.S.I. | Output | Closed |
| A to B | X | | 1340 | 10 | 31.2 | 1″ Open |
| B to C | X | | 1340 | 10 | 50.1 | 1″ Open |
| C to D | X | | 1340 | 10 | 75.5 | 1″ Open |
| D to E | X | | 1340 | 10 | 120.8 | 1″ Open |
| A to B | X | | 1780 | 12 | 48.9 | ½″ Open |
| B to C | X | | 1780 | 12 | 96.4 | ½″ Open |
| C to D | X | | 1780 | 12 | 144.5 | ½″ Open |
| D to E | X | | 1780 | 12 | 189.9 | ½″ Open |
| A to B | X | | 2230 | 14 | 91.3 | ¾″ Open |
| B to C | X | | 2230 | 14 | 180.5 | ¾″ Open |
| C to D | X | | 2230 | 14 | 273.8 | ¾″ Open |
| D to E | X | | 2230 | 14 | 359.8 | ¾″ Open |
| A to B | X | | 2810 | 21 | 130.3 | 1″ Closed |
| B to C | X | | 2810 | 21 | 250.9 | 1″ Closed |
| C to D | X | | 2810 | 21 | 390.4 | 1″ Closed |
| D to E | X | | 2810 | 21 | 498.0 | 1″ Closed |
| A to B | | X | 1262 | 11 | 20.8 | 1″ Open |
| B to C | | X | 1262 | 11 | 41.9 | 1″ Open |
| C to D | | X | 1262 | 11 | 62.8 | 1″ Open |
| D to E | | X | 1262 | 11 | 82.7 | 1″ Open |
| A to B | | X | 1480 | 14 | 29.9 | ½″ Open |
| B to C | | X | 1480 | 14 | 61.1 | ½″ Open |
| C to D | | X | 1480 | 14 | 88.3 | ½″ Open |
| D to E | | X | 1480 | 14 | 118.9 | ½″ Open |
| A to B | | X | 1980 | 17 | 41.8 | ¾″ Open |
| B to C | | X | 1980 | 17 | 84.9 | ¾″ Open |
| C to D | | X | 1980 | 17 | 126.6 | ¾″ Open |
| D to E | | X | 1980 | 17 | 169.9 | ¾″ Open |
| A to B | | X | 2150 | 20 | 75.5 | 1″ Closed |
| B to C | | X | 2150 | 20 | 149.8 | 1″ Closed |
| C to D | | X | 2150 | 20 | 224.1 | 1″ Closed |
| D to E | | X | 2150 | 20 | 297.0 | 1″ Closed |

As will be readily apparent to those of skill in the art, the output of the device will vary depending on the size and flow rate of the pool pump utilized. Although shown as being positioned adjacent to the pump 2, this is for illustrative purposes only, as the device 100 can be connected anywhere along the circulation system. Moreover, one or more outlets 152a (not illustrated) can also be provided in order to allow the device to power any number of external items such as lights, fountains and the like, in addition to, or instead of providing power back to the pump 2.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

What is claimed is:

1. A device for generating electricity from a pressurized water circulation system, said device comprising:
an elongated, generally tubular main body having a first end, a second end, and a hollow interior space;
a water inlet tube located along the first end of the main body, said inlet tube functioning to receive pressurized water from a circulation system;
a water outlet tube located along the second end of the main body, said outlet tube functioning to return the pressurized water back to the circulation system;
an electrical generator that is disposed within the interior space of the main body, said generator functioning to generate electrical energy from the pressurized water received from the water inlet tube;
a water volume regulator that is in communication with each of the water inlet tube, the water outlet tube and the electrical generator, said regulator functioning to control an amount of the pressurized water making contact with the electrical generator;
a voltage control unit that is in communication with each of the electrical generator and the water volume regulator, said voltage control unit functioning to control an operation of the water volume regulator; and
an electrical output device functioning to transmit the electrical energy generated by the electrical generator to an outside device.

2. The device of claim 1, wherein the electrical generator further comprises:
a rotor comprising an impeller that is moveably connected to an electromagnetic induction armature, said rotor being configured to receive the pressurized water within the electromagnetic induction armature from the input tube,
said impeller including a plurality of blades, each of said blades being configured to remain fully submerged within the water during device operation; and
a stator configured to generate electrical energy within a plurality of coils utilizing a magnetic flux generated by the electromagnetic induction armature when rotated adjacent to the stator.

3. The device of claim 2, wherein the pressurized water circulation system consists of a swimming pool circulation system having a plurality of supply lines, a pool filter and an electrically powered pool pump,
said input tube includes a dimension suitable for engaging at least one of an output of the pool pump and a supply line connected to the outlet of the pool pump,
said output tube includes a dimension suitable for engaging at least one of an input of the pool filter and a supply line connected to the input of the pool filter, and
said electrical output device is connected to the pool pump and functions to augment a power requirement of the pool pump.

4. The device of claim 3, wherein the main body includes a length of approximately 24 inches and a diameter of approximately 6 inches.

5. The device of claim 2, wherein the water volume regulator further comprises:
an electrically controlled liquid regulator configured to control a magnitude of liquid flow around the electrical generator in a non-discrete manner; and
said voltage control unit is further configured to control the liquid regulator to adjust a voltage of the generated electrical energy.

6. The device of claim 2, further comprising:
an electrical circuit electrically connected to the plurality of coils, the electrical circuit configured to modulate generated electrical energy.

7. The device of claim 6, wherein the electrical circuit includes circuitry for operating an electrical outlet using alternating current.

8. The device of claim 6, wherein the electrical circuit includes circuitry for providing a direct current power source.

9. The device of claim 2, wherein the impeller further comprises magnets that function to magnetically attract other magnets within the electromagnetic induction armature.

10. The device of claim 9, wherein the impeller further comprises a plurality of blades that are configured to generate rotational force from motion of the water flowing through the rotor, rotating the impeller and magnetically attracting the electromagnetic induction armature to rotate in a similar rotational motion.

11. The device of claim 2, wherein the impeller further comprises an elongated shaft that includes magnets on a first end and blades on a second end.

12. The device of claim 2, wherein the impeller is elliptical.

13. The device of claim 2, wherein the electromagnetic induction armature is moveably connected to the stator using ball bearings.

14. The device of claim 2, further comprising a user interface that is located along the main body.

15. The device of claim 1, wherein the electrical generator further comprises:
a rotor comprising a circular impeller mechanically connected to an electromagnetic induction armature, said rotor being configured to receive the pressurized water within the electromagnetic induction armature from the input tube,
said impeller being configured to operate while fully submerged within the water during device operation; and
a stator moveably connected to the electromagnetic induction armature and configured to generate electrical energy within a plurality of coils utilizing a magnetic flux generated by the electromagnetic induction armature when rotated adjacent to the stator.

16. The device of claim 14, wherein the pressurized water circulation system consists of a swimming pool circulation system having a plurality of supply lines, a pool filter and an electrically powered pool pump,
said input tube includes a dimension suitable for engaging at least one of an output of the pool pump and a supply line connected to the outlet of the pool pump,
said output tube includes a dimension suitable for engaging at least one of an input of the pool filter and a supply line connected to the input of the pool filter, and
said electrical output device is connected to the pool pump and functions to augment a power requirement of the pool pump.

17. The device of claim 15, wherein the main body includes a length of approximately 24 inches and a diameter of approximately 6 inches.

18. A system for circulating water through a pool, said system comprising:
a swimming pool circulation system that includes a pool filter, an electrically powered pool pump, and a plurality of water supply lines connected thereto; and
a device for generating electricity that includes
an elongated, generally tubular main body having a first end, a second end, and a hollow interior space,
a water inlet tube located along the first end of the main body, said inlet tube functioning to receive pressurized water from the pool pump,
a water outlet tube located along the second end of the main body, said outlet tube functioning to send the pressurized water to the pool filter,
an electrical generator that is disposed within the interior space of the main body, said generator functioning to generate electrical energy from the pressurized water received from the water inlet tube,
a water volume regulator that is in communication with each of the water inlet tube, the water outlet tube and the electrical generator, said regulator functioning to control an amount of the pressurized water making contact with the electrical generator,
a voltage control unit that is in communication with each of the electrical generator and the water volume regulator, said voltage control unit functioning to control an operation of the water volume regulator, and
an electrical output device functioning to transmit the electrical energy generated by the electrical generator to the pool pump.

19. The system of claim 18, wherein the electrical generator further comprises:
a rotor comprising an impeller that is moveably connected to an electromagnetic induction armature, said rotor being configured to receive the pressurized water within the electromagnetic induction armature from the input tube,
said impeller including a plurality of blades, each of said blades being configured to remain fully submerged within the water during device operation; and
a stator configured to generate electrical energy within a plurality of coils utilizing a magnetic flux generated by the electromagnetic induction armature when rotated adjacent to the stator.

20. The system of claim 19, wherein the main body includes a length of approximately 24 inches and a diameter of approximately 6 inches.
